(19) United States
(12) Patent Application Publication
(10) Pub. No.: US 2003/0192010 A1
(43) Pub. Date: Oct. 9, 2003

(54) Issue reporting process

(76) Inventor: Robert Hurst, Hemel Hempstead (GB)

Correspondence Address: Mr. Robert A. Hurst, 15 Highcroft Road, Feldon, Hemel Hempstead, Hertfordshire, HP3 0BU, GB

(21) Appl. No.: 10/159,132

(22) Filed: May 22, 2002

(30) Foreign Application Priority Data
Apr. 9, 2002 (GB) RAH/ISSUE 01

(51) Int. Cl. G06F 17/24; G06F 17/21

(52) U.S. Cl. 715/513; 715/530

(57) ABSTRACT

An Intelligent Issue Reporting Process has an interface to guide the process, as shown in FIGS. 1-7. The process allows reporting as shown in FIGS. 3-4, and produces reports as shown in FIGS. 5-7.

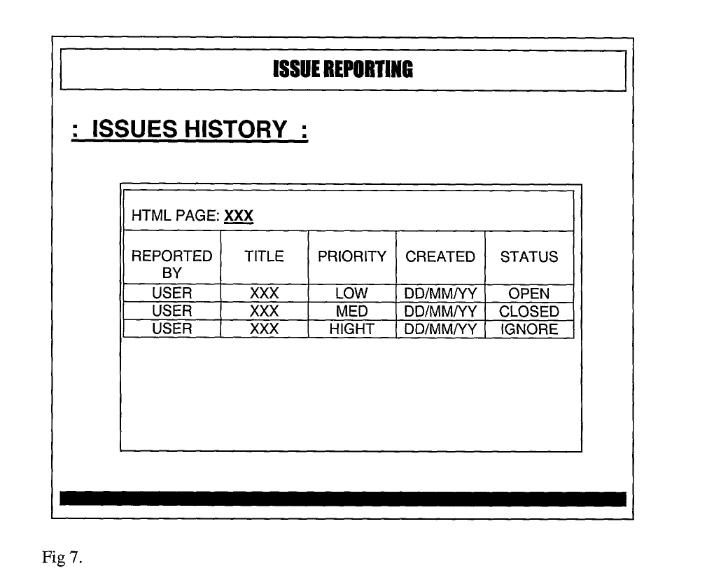

New Reporting pages can be added via the interface shown in FIG. 2. When a page is added/deleted it is added/removed from 3 FIG. 7.

### TECHNICAL FIELD

This invention relates to a Real Time Issue Reporting Process.

### BACKGROUND

WebPages are widely used for a number of reasons ranging from marketing to conveying information on the Internet. They are made up of a combination of programming languages, all held together in HTML. If there are errors or changes, which need to be made on the pages, they are currently reported manually outside of the page.

### ESSENTIAL TECHNICAL FEATURES

According to the present invention there is provided an Issue Reporting Process, comprising of a program, which converts WebPages to reporting pages and updates them in real-time. The Issue Reporting Process consists of a method: allowing the upload of an HTML page, which is then converted to allow issues to be reported and viewed directly on the page itself.

The Issue Reporting tool has the following features:

1. The page has all the visual characteristics of the original web page

2. Issues are reported directly on the page

3. Issues reported are shown directly on the page in the precise location reported

4. Issues can be updated

5. Reports for complete history of issues reported is displayed

6. Updating in Real Time

### EXAMPLE

The invention (process) shall now be described by way of example with reference to the accompanying images:

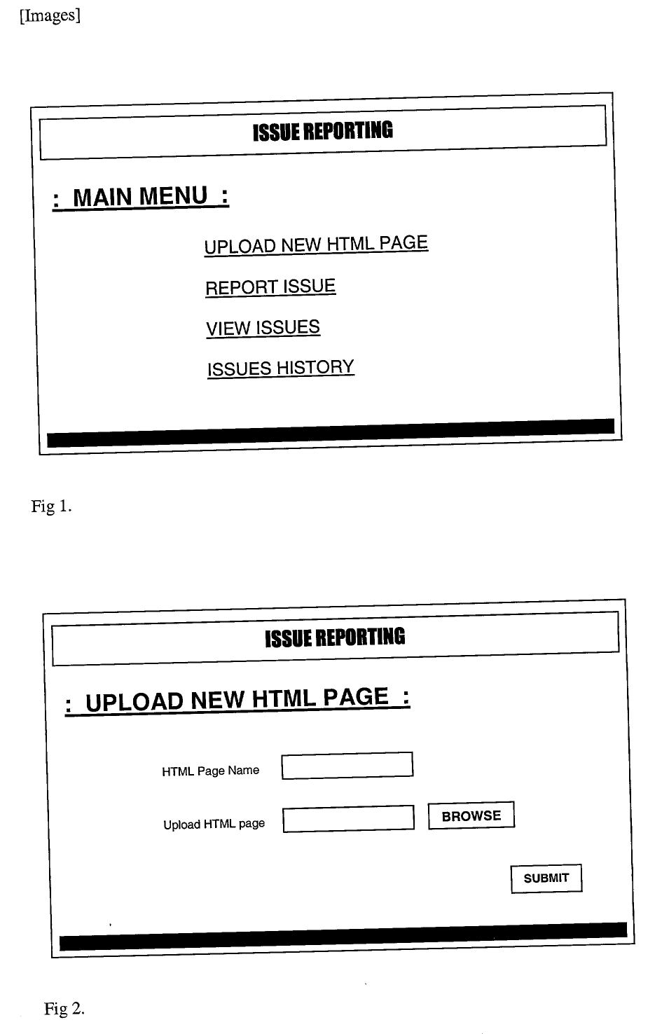

FIG. 1. Shows the Main menu options for the Issue Reporting tool.

FIG. 2. Shows the process to create a new Issue Reporting page (Requires an upload of a HTML page to the system)

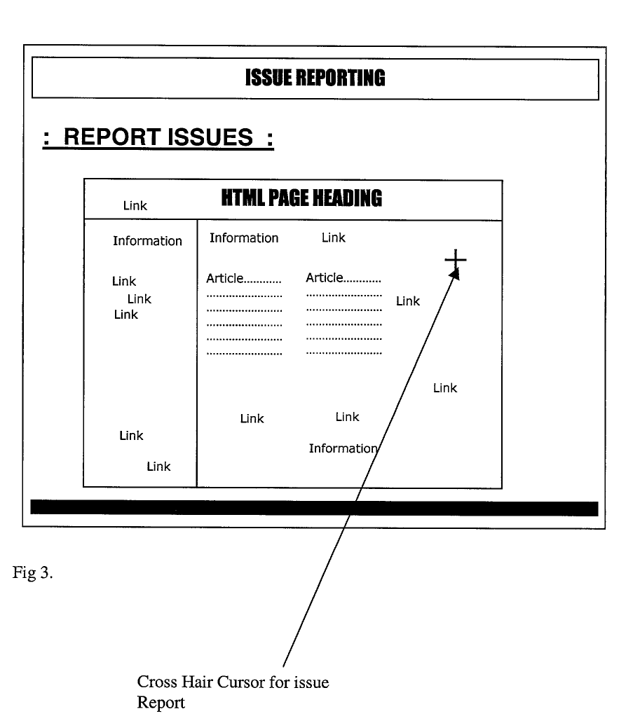

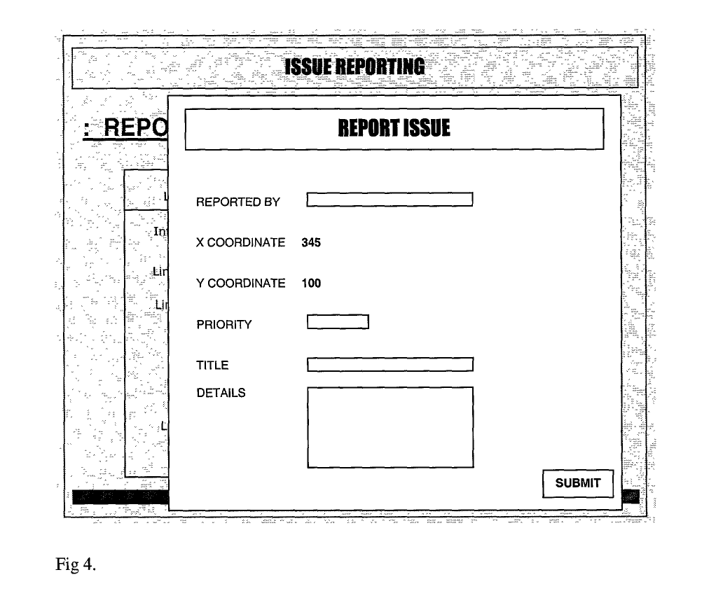

FIGS. 3-4. Illustrates how issues are reported directly on to the page where the changes required need to be made.

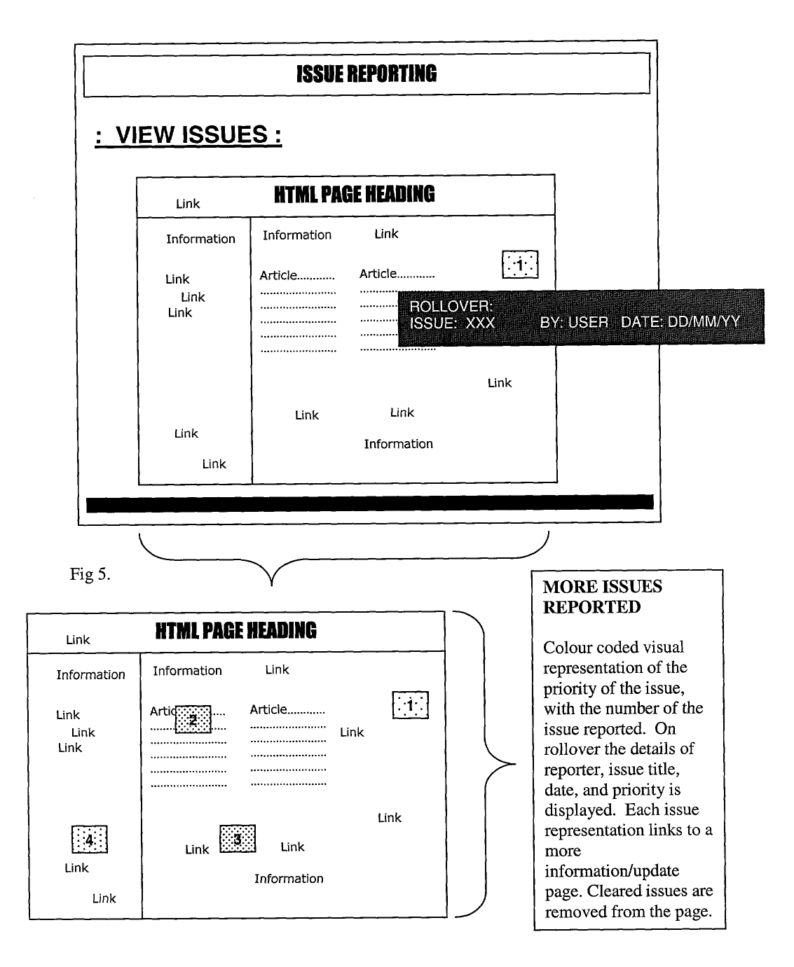

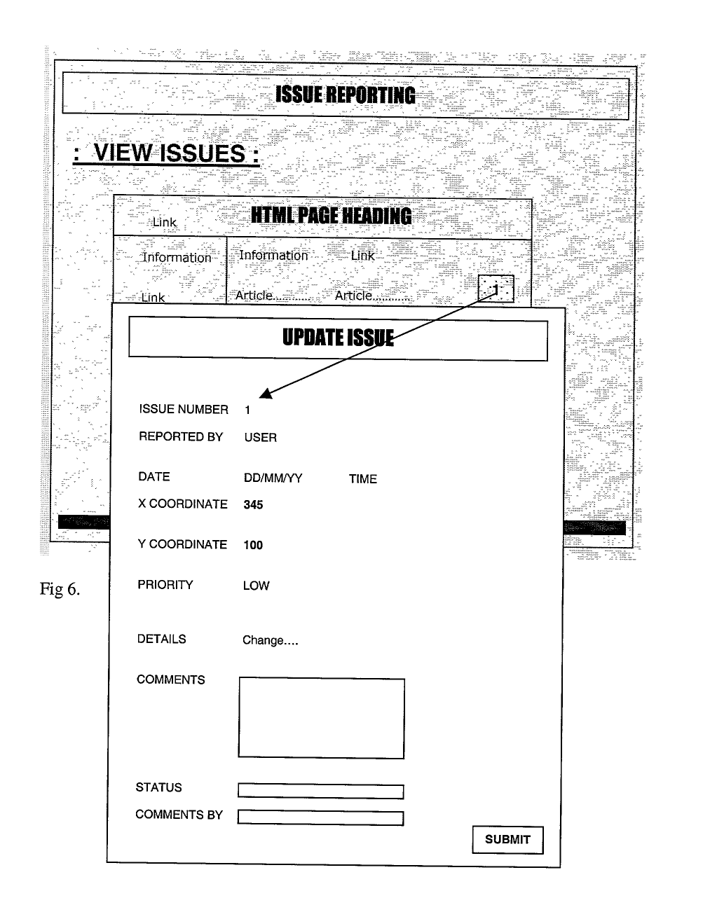

FIG. 5. Shows a visual representation with the aid of colours, numbers, and rollovers, the precise location of the issue and its details.

FIG. 6. Illustrates how issues reported can be updated, ignored, and signed off as complete from the Issue Report page.

FIG. 7. Shows the complete list of information for all issues reported using the Issue Reporting Process.

1. According to the present invention there is provided an Issue Reporting Process, comprising of a program, which converts WebPages to reporting pages and updates them in real-time. The Issue Reporting Process consists of a method: allowing the upload of an HTML page, which is then converted to allow issues to be reported and viewed directly on the page itself.

2. An Issue Reporting Process as claimed in claim 1, where an interface is provided to guide the user through the process of creating, reporting, and viewing.

3. An Issue Reporting Process as claimed in claim 2, where an interface is provided for the real time issue reporting process to represent the visual characteristics of the original HTML, including issue report markers as numbers, colours, and rollovers or a combination of all three.
